(19) United States
(12) Patent Application Publication
(10) Pub. No.: US 2009/0060495 A1
(43) Pub. Date: Mar. 5, 2009

(54) INITIATING DIAGNOSTICS FROM ANY USER COMMUNICATION TERMINAL

(75) Inventors: Michael J. Wurst, Santa Rosa, CA (US); Forrest J. Chesser, Caddo Mills, TX (US)

Correspondence Address: FITZPATRICK CELLA HARPER & SCINTO, 30 ROCKEFELLER PLAZA, NEW YORK, NY, 10112, US

(73) Assignee: TELLABS PETALUMA, INC., Naperville, IL (US)

(21) Appl. No.: 11/850,584

(22) Filed: Sep. 5, 2007

(51) Int. Cl. H04B 10/08

(52) U.S. Cl. 398/16

(57) ABSTRACT

A method for initiating diagnostic operations for a communication network, and devices, a network, and computer-readable storage medium storing control logic, that operate in accordance with the method. A test set device is communicatively coupled to a test head. The test set device provides access information to the test head, the access information comprising a diagnostic code indicating a diagnostic operation to be performed. The test head is communicatively coupled to a network. The test head provides the diagnostic code to the network device and sends a response from the network device to the test set device, the response indicating a result of performing the diagnostic operation. In this manner, a field technician can initiate diagnostics without the intervention of another technician, thereby reducing manpower required to troubleshoot a problem and improve troubleshooting turnaround.

### BACKGROUND OF THE INVENTION

1. Field of the Invention

This invention relates generally to diagnostics and troubleshooting for network equipment, and, more particularly, to initiating diagnostic operations for network equipment using a signaling protocol.

2. Description of Related Art

There is a growing demand in the industry to find a solution to transmit voice, data, or video from a headend to a subscriber's premises through a fiber optic network all the way into an individual home or business. Such fiber optic networks generally are referred to as fiber-to-the-home (FTTH), fiber-to-the-premises (FTTP), fiber-to-the-business (FTTB), fiber-to-the-node (FTTN), or fiber-to-the-curb (FTTC) networks and the like, depending on the specific application of interest. Such types of networks are also referred to herein generally as “FTTx networks”.

In a FTTx network, equipment at a headend or central office couples the FTTx to external services such as a Public Switched Telephone Network (PSTN) or an external network. Signals received from these services are converted into optical signals and are combined onto a single optical fiber at a plurality of wavelengths, with each wavelength defining a channel within the FTTx network.

In a FTTP network, the optical signals are transmitted through the FTTP network to an optical splitter that splits the optical signals and transmits the individual optical signals over a single optical fiber to a subscriber's premises. At the subscriber's premises, the optical signals are converted into electrical signals using an Optical Network Terminal (ONT). The ONT may split the resultant signals into separate services required by the subscriber such as computer networking (data), telephony and video.

In FTTC and FTTN networks, the optical signal is converted to an electrical signal by either an Optical Network Unit (ONU) (FTTC) or a Remote Terminal (RT) (FTTN), before being provided to a subscriber's premises.

A typical FTTx network often includes one or more Optical Line Terminals (OLTs) which each include one or more Passive Optical Network (PON) cards. Such a typical network is illustrated in FIG. 1. Each OLT typically is communicatively coupled to one or more ONT (in the case of a FTTP network), or to one or more Optical Network Units (ONU) (in the case of a FTTC network), via an Optical Distribution Network (ODN). In a FTTP network the ONTs are communicatively coupled to customer premises equipment (CPE) used by end users (e.g., customers or subscribers) of network services. In a FTTC network, the ONU's are communicatively coupled to network terminals (NT), and the NTs are communicatively coupled to CPE. NTs can be, for example, digital subscriber line (DSL) modems, asynchronous DSL (ADSL) modems, very high speed DSL (VDSL) modems, or the like.

In a FTTN network, each OLT typically can be communicatively coupled to one or more RTs. The RTs are communicatively coupled to NTs that are communicatively coupled to CPE.

When, for example, an ONT is deployed at the subscriber's premises, diagnostic tests such as Metallic Loop Tests (MLT) and Draw Break Dial Tone Tests (DBDT) are initiated by an operator from an Element Management System (EMS). In typical network deployments, an EMS Server manages a large multi-state region of equipment. The network operator using the EMS often is geographically distant from the customers being serviced. If the diagnostic tests indicate a problem, a field technician is sent to the subscriber's premises to troubleshoot the problem. Because the field technician typically does not have access to the diagnostic tools, the field technician must request another technician (network operator) located at the EMS to run the diagnostic tests from the EMS. Furthermore, because the ONT does not provide an indication of the state of voice services, such as its provisioning or alarm state, the field technician must pick up, for example, a telephone and listen for a dial tone to verify that voice service is available. The field technician does not have any visibility to the alarm state or root cause of the problem. Therefore, the field technician's troubleshooting options at the subscriber's premises may be to power cycle the ONT, replace the ONT, or call a network operator for assistance. If the root cause of the problem is a network failure (e.g., router failure), these options may not correct the problem.

U.S. Pat. No. 7,123,692 describes an ONT that provides test information to a BUTT set (lineman's handset) display using Caller ID signaling, and receives data from a BUTT set via DTMF-enabled keys of the BUTT set. However, because a BUTT set connects to an ONT at a subscriber's premises, a field technician needs to be at the subscriber's premises to receive test information from the ONT via the BUTT set. Additionally, because the test information is received via a display using Caller ID signaling, a BUTT set having a display and capable of receiving Caller ID data must be used.

It would be useful, therefore, to provide an improved technique for initiating diagnostic tests which enables field technicians to initiate diagnostic tests on their own, and to initiate diagnostic tests without being present at the subscriber's premises, thereby reducing the manpower required to troubleshoot problems and improve troubleshooting turnaround.

### SUMMARY OF THE INVENTION

The foregoing and other limitations are overcome by a method for initiating diagnostic operations for a communication network, and by devices, a network, and computer-readable storage medium storing control logic, that operate in accordance with the method.

According to an example aspect of the invention, a test set device is communicatively coupled to a test head. The test set device provides access information to the test head, the access information comprising a diagnostic code indicating a diagnostic operation to be performed. The test head provides the diagnostic code to the network device and sends a response from the network device to the test set device, the response indicating a result of the diagnostic operation.

The network device can be at least one of, for example, an optical network terminal (ONT), an optical network unit (ONU), and an optical line terminal (OLT). The test set device can include at least one of, for example, a telephone and a computer with a soft phone.

The diagnostic operation can be performed at least in part by the network device, and the diagnostic operation can include, for example, running a test and reporting network information. The test can include at least one of a Metallic Loop Test (MLT), a Draw Break Dial Tone Test (DBDT), an IP Ping, and a trace route, and the network information can include at least one of a network alarm state and a state of the network device.

The access information can be provided by the test set as, for example, a DTMF digit sequence, and the access information can be inputted in the test set device in an audible format. The access information can include authenticating information.

The test head can provide the diagnostic code to the network device using, for example, a session initiation method, the session initiation method specifying a request to suppress ringing at the network device.

The response can include an audio signal indicating the result. According to an example embodiment of the invention, the network device sends the response to the test set device via the test head. Also, according to an example embodiment of the invention, the network device sends the response to the test set device.

According to another example aspect of the invention, a test set device provides access information to a network device. The access information includes a diagnostic code indicating a diagnostic operation to be performed. The network device sends the test set device a response including an audio signal indicating a result of the diagnostic operation.

The test set device can be instructed to communicatively de-couple from the network device. In response to the test set device communicatively de-coupling from the network device, the diagnostic operation can be performed. The network device and the test set device can be communicatively coupled before sending the response.

### BRIEF DESCRIPTION OF THE DRAWINGS

The present invention will be more readily understood from a detailed description of the example embodiments taken in conjunction with the following figures:

FIG. 1 represents a conventional FTTx network.

FIG. 2 is a block diagram of a communication system 1 that is suitable for practicing this invention.

FIG. 3 is a block diagram of a user communication terminal that operates within the system 1 of FIG. 2.

FIG. 4 is a network diagram of an example passive optical network (PON), which may be a more detailed version of one or more of the networks of the system 1 of FIG. 2.

FIG. 5 is an architecture diagram of a data processing system in accordance with an example embodiment of the invention.

FIG. 6 is a flow diagram that illustrates a method for initiating diagnostics remotely in accordance with an example embodiment of this invention.

FIG. 7 is a flow diagram that illustrates a method for initiating diagnostics locally in accordance with an example embodiment of this invention.

FIG. 8 is a logical diagram of functional modules in accordance with an example embodiment of the invention.

Identically labeled elements appearing in different ones of the figures refer to the same elements but may not be referenced in the description for all figures.

### DETAILED DESCRIPTION OF THE EMBODIMENTS

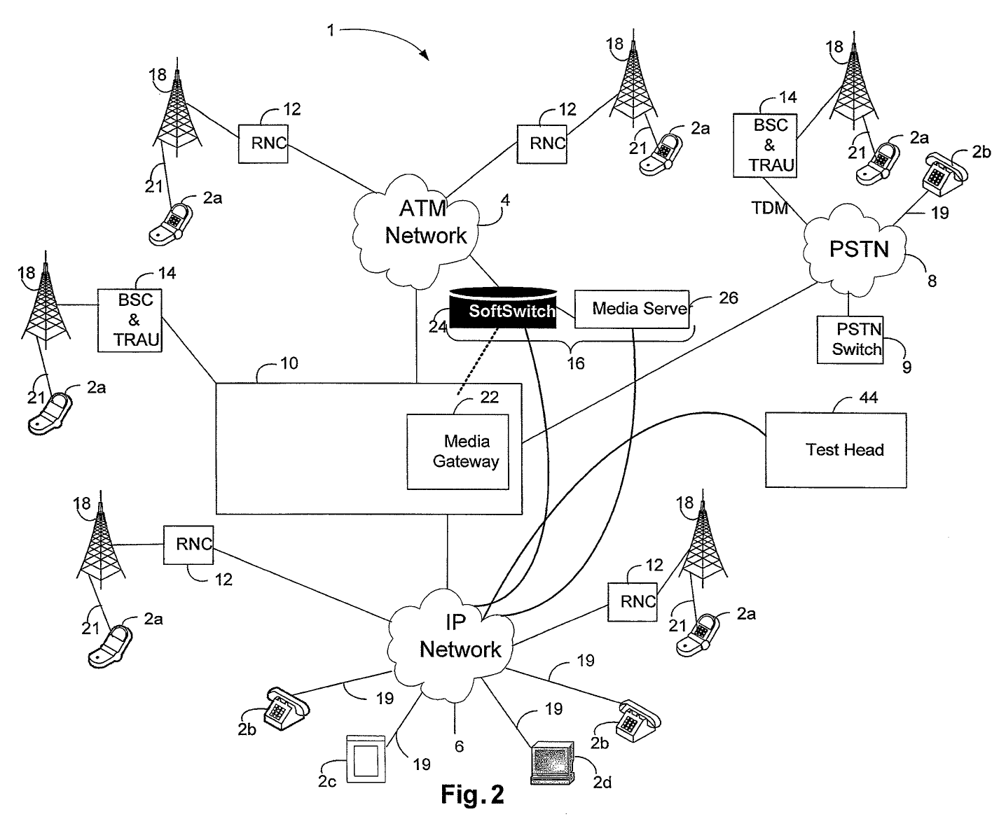

FIG. 2 is a block diagram of a communication system 1 that is suitable for practicing this invention. In the illustrated embodiment, the communication system 1 comprises customer premises equipment such as user communication terminals (devices) 2a, 2b, video devices 2c, computer terminals 2d, and also comprises a plurality of communication networks 4, 6, 8, a gateway 10, and various communication and/or control stations such as, for example, Radio Network Controllers (RNCs) 12, Base station Controllers (BSCs) and Transcoder Rate Adaptor Units (TRAUs), the latter two of which are shown and referred to hereinafter collectively as BSCs/TRAUs 14, base sites or base stations 18, and an Integrated Multimedia Server (IMS) 16. Traditionally, various types of interconnecting mechanisms may be employed for interconnecting the above components as shown in FIG. 2, such as, for example, optical fibers, wires, cables, switches, wireless interfaces, routers, modems, and/or other types of communication equipment, as can be readily appreciated by one skilled in the art, although, for convenience, no such mechanisms are explicitly identified in FIG. 2, besides wireless and wireline interfaces 21 and 19, respectively.

According to an example embodiment of the invention, the communication terminals 2a can function as test set devices for performing the methods of this invention to be described below. In the illustrated embodiment, the user communication terminals 2a are depicted as cellular radiotelephones that include an antenna for transmitting signals to and receiving signals from a base station 18 responsible for a given geographical cell, over a wireless interface 21. The user communication terminals 2a can be capable of operating in accordance with any suitable wireless communication protocol, such as IS-136, GSM, IS-95 (CDMA), wideband CDMA, narrow-band AMPS (NAMPS), and TACS. Communication terminals 2a may be dual or higher mode phones (e.g., digital/analog or TDMA/CDMA/analog phones), or phones using so called “Voice-Over-IP” technology, such as H.323, H.248, and SIP protocols. It should thus be clear that the user communication terminal 2a can be capable of operating with one or more air interface standards, communication protocols, modulation types, and access types, and that the teaching of this invention is not limited for use with any particular one of those standards/protocols, etc.

The RNCs 12 are each communicatively coupled to a neighboring base station 18 and a corresponding network 4 or 6, and are capable of routing calls and messages to and from the user communication terminals 2a when the terminals are making and receiving calls. The RNCs 12 route such calls to the networks 6 and 4. The BSC portion of the BSCs/TRAUs 14 typically controls its neighboring base station 18 and controls the routing of calls and messages between terminals 2a and other components of the system 1 coupled bidirectionally to the respective BSC/TRAU 14, such as, for example, gateway 10 and network 8, and the TRAU portion of the BSCs/TRAUs 14 performs rate adaptation functions such as those defined in, for example, GSM recommendations 04.21 and 08.20 or later versions thereof. The base stations 18 typically have antennas to define their geographical coverage area.

According to the illustrated embodiment, network 8 is the PSTN that routes calls via one or more switches 9, the network 4 operates in accordance with Asynchronous Transfer Mode (ATM) technology, and the network 6 represents the Internet, adhering to TCP/IP protocols, although the present invention should not be construed as being limited for use only with one or more particular types of networks. Also, user communication terminals 2b are depicted as landline telephones, that are bidirectionally coupled to network 6 or 8. According to an example embodiment of the invention, the communication terminals 2b also can function as test set devices for performing the methods of this invention to be described below.

The gateway 10 includes a media gateway 22 that acts as a translation unit between disparate telecommunications networks such as the networks 4, 6, and 8. Typically, media gateways are controlled by a media gateway controller, such as a call agent or a soft switch 24 which provides call control and signaling functionality, and enable multimedia communications across networks over multiple transport protocols, such as by providing conversions between TDM voice and Voice over Internet Protocol (VoIP), radio access networks of a public land network, and Next Generation Core Network technology, etc. Communication between media gateways and soft switches often is achieved by means of protocols such as, for example, MGCP, Megaco, H.248 or Session Initiation Protocol (SIP).

Media server 26 is a computer or farm of computers that facilitate the transmission, storage, and reception of information between different points, such as between networks (e.g., network 6) and soft switch 24 coupled thereto. From a hardware standpoint, a server 26 typically includes one or more components, such as one or more microprocessors (not shown in FIG. 2), for performing the arithmetic and/or logical operations required for program execution, and disk storage media, such as one or more disk drives (not shown in FIG. 2) for program and data storage, and a random access memory, for temporary data and program instruction storage. From a software standpoint, a server 26 typically includes server software resident on the disk storage media, which, when executed, directs the server 26 in performing transmission and reception functions. The server software runs on an operating system stored on the disk storage media, such as, for example, UNIX or Windows NT, and the operating system can adhere to TCP/IP protocols. As is well known in the art, server computers can run different operating systems, and can contain different types of server software, each type devoted to a different function, such as handling and managing data/information from a particular source, or transforming data/information from one format into another format. It should thus be clear that the teaching of this invention is not to be construed as being limited for use with any particular type of server computer, and that any other suitable type of device for facilitating the exchange and storage of information may be employed instead.

According to an example embodiment of the invention, the system 1 of FIG. 2 also includes one or more test heads 44 that operate in accordance with the method of this invention to perform diagnostic operations.

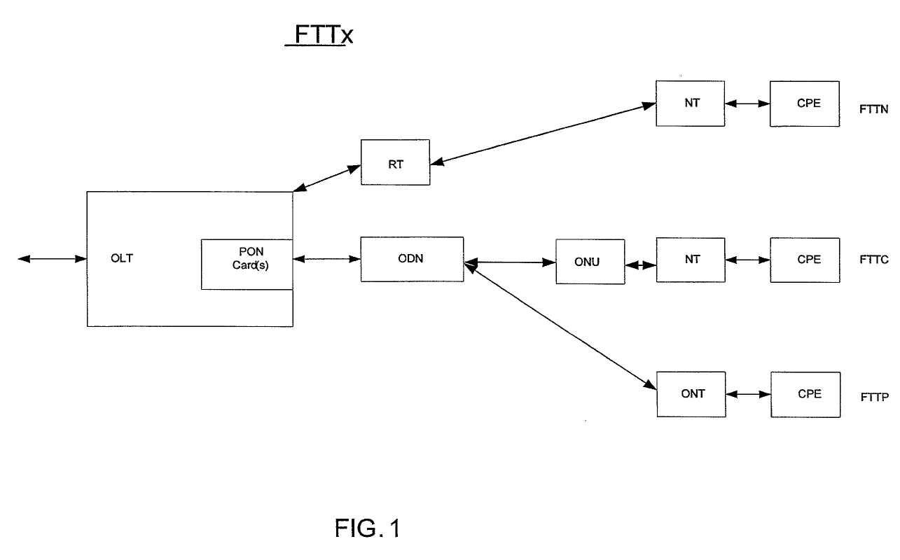

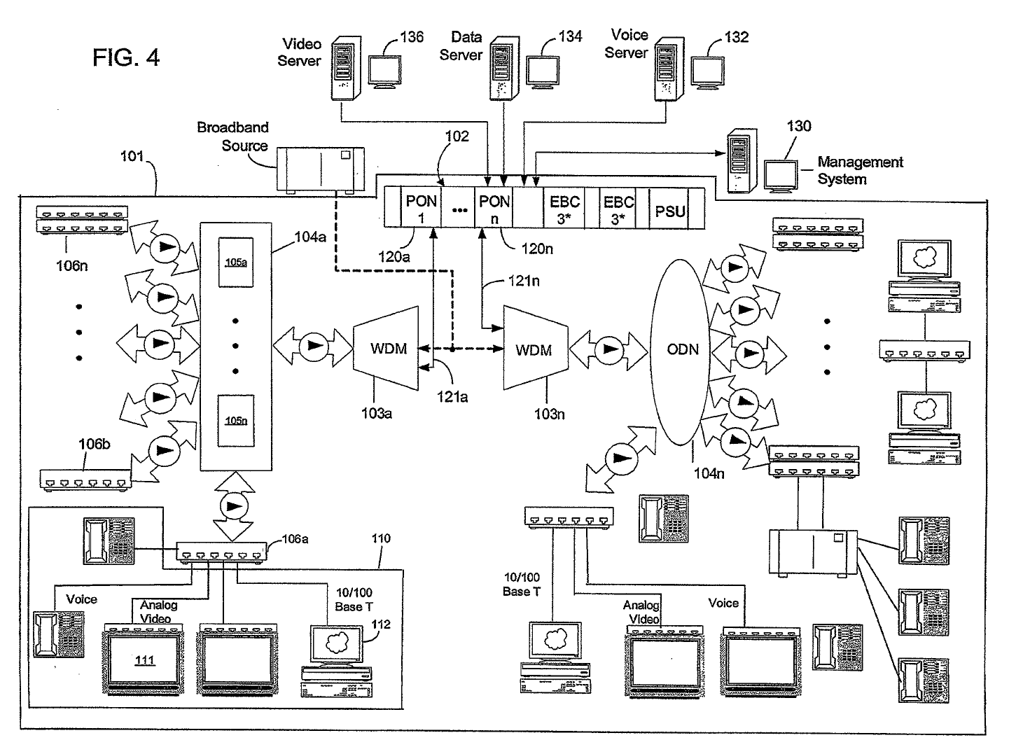

Test head 44 may be provided at any location within the system 1, although in the illustrated example, test head 44 is depicted as being in communication with network 6. Generally speaking, the specific location of a test head 44 varies depending on predetermined system design and operating criteria, so long as a test set device (e.g., one of terminals 2a or 2b of FIG. 2, or customer premises equipment 110 of FIG. 4) can form a call communication path with test head 44 to exchange communications between the test set device and a network device supporting a signaling stack to perform a method of this invention. Devices supporting signaling stacks can include, for example, ONTs (e.g., 106a-n communicatively coupled to network 6 as shown and described in connection with FIG. 4 below), OLTs (e.g., 102 of FIG. 4), ONUs (e.g., of FIG. 1), smart appliances (e.g., refrigerators), set top devices, copiers/facsimile devices, and any other suitable network device.

Test set devices can establish a call communication path with test head 44 to enable test head 44 to perform the method of the invention to be described below. Test head 44 can use a media gateway controller, such as a call agent or soft switch 24, to provide signaling functionality and establish communication paths with devices, such as for example, ONTs 106a-n, using an application-layer control (signaling) protocol (e.g., SIP and H. 248) for creating, modifying, and terminating sessions with one or more participants. These sessions include, for example, Internet telephone calls, multimedia distribution, and multimedia conferences. SIP is a lightweight, transport independent, text based protocol, and is widely used as a signaling protocol for VoIP and others. VoIP, also typically referred to as IP Telephony, Internet telephony, Broadband telephony, Broadband Phone, and Voice over Broadband, is the routing of voice conversations over the Internet or through any other IP-based network.

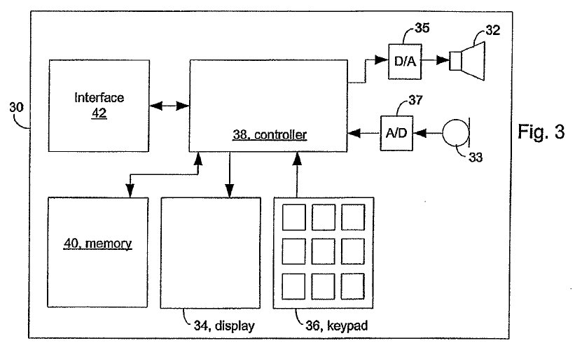

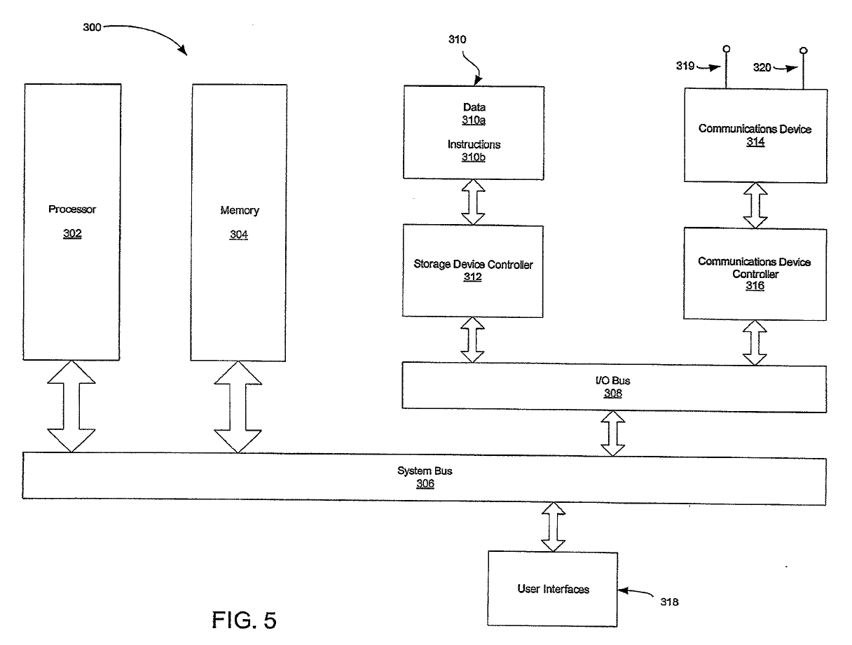

Referring now to FIG. 3, an example embodiment of an individual user communication terminal 2a, 2b is shown, and is identified by reference numeral 30. The user communication terminal 30 includes an interface 42 for communicatively coupling the terminal 30 to an external communication interface, such as the interface 21 (FIG. 2), in the case of user communication terminal 2a, or wireline interface 19 or 320 (FIG. 5), in the case of user communication terminal 2b. For example, the interface 42 may include a transceiver and an antenna (in the case of terminal 2a) for enabling the terminal 30 to exchange information with the external interface. That information may include, for example, signaling information in accordance with the external interface standard employed by the respective network coupled to the terminal 30, user speech, and data.

A user interface of the terminal 30 includes a conventional speaker 32, a display 34, a user input device, typically a keypad 36, and a transducer device, such as a microphone 33, all of which are coupled to a controller 38 (CPU), although in other embodiments, other suitable types of user interfaces also may be employed. The keypad 36 includes the conventional numeric (0-9) and related keys (#, *), and can include other keys that are used for operating the user communication terminal 30, such as, for example, a SEND key (terminal 2a), various menu scrolling and soft keys, etc. A digital-to-analog (D/A) converter 35 is interposed between an output of the controller 38 and an input of the speaker 32. The D/A converter 35 converts digital information signals received from the controller 38 into corresponding analog signals, and forwards those analog signals to the speaker 32, for causing the speaker 32 to output a corresponding audible signal. An analog to digital (A/D) converter 37 is interposed between an output of the microphone 33 and an input of the controller 38, and operates by repetitively sampling and then digitizing analog signals received from the microphone 33, and by providing digital audio (e.g., speech) samples representing the resulting digital values to the controller 38.

When the user communication terminal 30 is engaged in an established call, communication signals (representing, for example, speech, other acoustic information, and/or data) that are received through the interface 42 and destined to be outputted through speaker 32, are forwarded to the controller 38 before being outputted through the speaker 32. Signals that are inputted through the microphone 33 during the call also are forwarded to the controller 38, before being transmitted to their intended destination through, for example, interface 42.

The user communication terminal 30 also includes various memories, such as a RAM, a ROM, and a Flash memory, shown collectively as the memory 40. An operating program for controlling the operation of controller 38 also is stored in the memory 40 (typically in the ROM) of the user communication terminal 30, and may include routines to present messages and message-related functions to the user on the display 34, typically as various menu items.

It should be noted that the total number and variety of user communication terminals which may be included in the overall communication system 1 can vary widely, depending on user support requirements, geographic locations, applicable design/system operating criteria, etc., and are not limited to those depicted in FIG. 2. Also, this invention may be employed in conjunction with any suitable types of communication protocols, including, but not limited to, for example, Internet telephony protocols, ATM telephony protocols, GSM cellular telephony protocols, and ANSI ISUP. Moreover, although in FIG. 2 the user communication terminals 2a, 2b are depicted as a radiotelephone and a conventional, non-wireless telephone, respectively, any other suitable types of user communication terminals and/or information appliances may be employed, in addition to, or in lieu of, those components. For example, in other embodiments, and where appropriate, one or more of the individual terminals 2a, 2b may be embodied as a personal digital assistant, a handheld personal digital assistant, a computer with a soft phone, a palmtop computer, and the like. It also should be noted that, although the invention is described in the context of the various devices 2a, 2b communicating with other components through the networks 4, 6, 8, broadly construed, the invention is not so limited. For example, one or more of the user communication devices 2a, 2b may communicate with one another through other suitable interfaces, and/or may be included within a same network. In general, the teaching of this invention may be employed in conjunction with any suitable type of communication system in which communications are exchanged between at least two points. It should thus be clear that the teaching of this invention is not to be construed as being limited for use with any particular type of user communication system, user terminal or communication protocol.

FIG. 4 is a network diagram of an example communication system or network, which may be a more detailed version of one or more of the networks of FIG. 2, such as, for example, network 6. A Passive Optical Network (PON) 101 of the system includes an optical line terminal (OLT) 102, wavelength division multiplexers 103a-n, optical distribution network (ODN) devices 104a-n, ODN device splitters (e.g., 105a-n associated with ODN device 104a), optical network terminals (ONTs) (e.g., 106-n corresponding to ODN device splitters 105a-n), and customer premises equipment (e.g., 110). The OLT 102 includes PON cards 120a-n, each of which provides an optical feed (121a-n) to ODN devices 104a-n. Optical feed 121a, for example, is distributed through corresponding ODN device 104a by separate ODN device splitters 105a-n to respective ONTs 106a-n, in order to provide communications to and from customer premises equipment 110 operably coupled to a port (e.g., 320 of FIG. 5) of the ONT.

The PON 101 may be deployed for fiber-to-the-business (FTTB), fiber-to-the-curb (FTTC), and fiber-to-the-home (FTTH) applications, for example. The optical feeds 121a-n in PON 101 may operate at bandwidths such as 155 Mb/sec, 622 Mb/sec, 1.25 Gb/sec, and 2.5 Gb/sec or any other desired bandwidth implementations. The PON 101 may incorporate, for example, ATM communications, broadband services such as Ethernet access and video distribution, Ethernet point-to-multipoint topologies, BPON communications, GPON communications, EPON communications, and native communications of data and time division multiplex (TDM) formats. Customer premises equipment (e.g., 110) which can receive and provide communications in the PON 101 may include standard telephones (e.g., Public Switched Telephone Network (PSTN)), Internet Protocol telephones, Ethernet units, video devices (e.g., 111), computer terminals (e.g., 112), any type of user communication device described above in connection with FIG. 2, digital subscriber line connections, cable modems, wireless access, as well as any other type of customer premise equipment.

PON 101 can include one or more different types of ONTs (e.g., 106a-n). Each ONT 106a-n, for example, is operably coupled with an ODN device 104a through associated ODN device splitters 105a-n via a data port (i.e., 319 of FIG. 5). Each ODN device 104a-n in turn communicates with an associated PON card 120a-n through respective wavelength division multiplexers 103a-n. Wavelength division multiplexers 103a-n are optional components which are used when video services are provided. Communications between the ODN devices 104a-n and the OLT 102 occur over a downstream wavelength and an upstream wavelength. The downstream communications from the OLT 102 to the ODN devices 104a-n may be provided at, for example, 622 megabytes per second, which is shared across all ONTs connected to the ODN devices 104a-n. The upstream communications from the ODN devices 104a-n to the PON cards 120a-n may be provided at, for example, 155 megabytes per second, which is shared among all ONTs connected to ODN devices 104a-n, although the invention is not limited to those specific types of downstream and upstream communications only, and may also include the types of example communications referred to above or any other suitable types of communications.

FIG. 4 further illustrates the OLT 102 managed by an element management system (EMS) 130. Since the OLT 102 includes the PON cards 120a-n, each PON card 120a-n is also managed by the EMS 130. As such, a single EMS manages all PON cards within a PON.

A single EMS, however, may manage or otherwise be associated with more than one PON. As such, a single EMS is not limited to managing PON cards within a single PON, but may manage PON cards from several PONs. In other embodiments, more than one EMS can be employed to manage one or more PON cards within a single PON or plural PONs.

FIG. 4. also illustrates plural servers, such as, for example a server 132 that supports voice applications, a server 134 that supports data applications, and a server 136 that supports video applications, although in other embodiments the functionality of those servers may be performed by only a single server or by a combination of servers. In still other example embodiments, the servers 132, 134, 136, and/or EMS 130 can be formed by a single server device or a combination of server devices, or no EMS 130 need be provided and the functionality of the EMS 130 can be provided by the servers 132, 134, and 136.

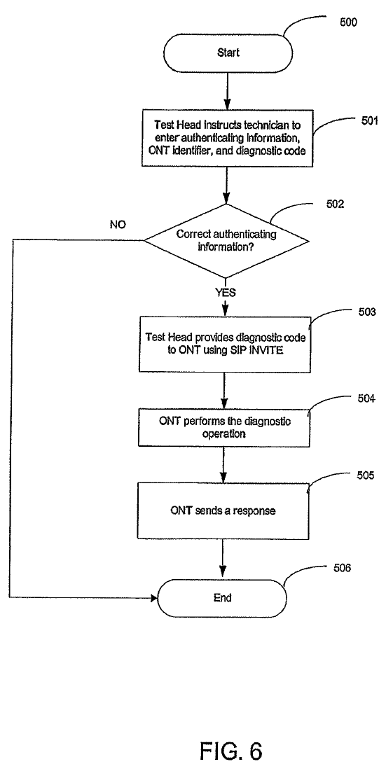

FIG. 5 is an architecture diagram of an example data processing system or device 300, which, according to an example embodiment, can form individual ones of the components ONU of FIG. 1, 44 of FIG. 2, and 102, 106a-n, and 110 of FIG. 4, and/or any other type of a network device supporting a signaling stack. Data processing system 300 includes a processor 302 coupled to a memory 304 via system bus 306. Processor 302 is also coupled to external Input/Output (I/O) devices (not shown) via the system bus 306 and an I/O bus 308, and at least one input/output user interface 318. Processor 302 may be further coupled to a communications device 314 via a communications device controller 316 coupled to the I/O bus 308. Processor 302 uses the communications device 314 to communicate with a network, such as, for example, a network as shown in any of FIGS. 2 and 4. In the case of at least the ONTs 106a-n, device 314 has data port 319 operably coupled to a network (e.g., PON 101) for sending and receiving data, and voice services data port 320 operably coupled to customer premises equipment (e.g., 110) for sending and receiving voice data, but device 314 may also have one or more additional input and output ports. A storage device 310 having a computer-readable medium is coupled to the processor 302 via a storage device controller 312 and the I/O bus 308 and the system bus 306. The storage device 310 is used by the processor 302 and controller 312 to store and read/write data 310a, and to store program instructions 310b used to implement the procedures described below in connection with FIGS. 6 and/or 7. The storage device 310 also stores various routines and operating programs (e.g., Microsoft Windows, UNIX/LINUX, or OS/2) that are used by the processor 302 for controlling the overall operation of the system 300. In the case of a network device supporting a signaling stack (e.g., ONTs 106a-n), at least one of the programs stored in storage device 310 adheres to a signaling protocol (e.g., SIP or H. 248), for providing signaling functionality and establishing communication paths with devices, such as, for example, test head 44. At least one of the programs (e.g., Microsoft Winsock) stored in storage device 310 can adhere to TCP/IP protocols (i.e., includes a TCP/IP stack), for implementing a known method for connecting to the Internet or another network.

In operation, processor 302 loads the program instructions 310b from the storage device 310 into the memory 304. Processor 302 then executes the loaded program instructions 310b to perform any of the example methods described below, for operating the system 300 (which forms individual ones of the components, such as, an ONU, test head 44, ONTs 106a-n, OLTs 102, and other devices supporting signaling stacks).

In the case of a network device supporting a signaling stack, the instructions 310b stored in the storage device 310 also include instructions which, when executed by the processor 302, enable the detection of alarms and the like, and also enable such detections to be notified via the at least one input/output user interface 318 and forwarded via communications device 314 to another destination such as, for example, ONU of FIG. 1, OLT 102, ONT 106a-n, and/or device 130, 132, 134, 136.

According to an example aspect of the invention, instructions 310b stored on storage device 310 enable the system 300 to communicate with at least one soft switch (FIG. 2) and/or to provide at least one communication channel to at least one other switch (not shown), wherein in either case the at least one channel is accessible at other ones of the mentioned devices.

In the case of at least the test head 44, the storage device 310 also stores instructions 310b which enable the system 300 to (i) provide a diagnostic code to a network device (e.g., ONT 106a-n) in response to receiving the diagnostic code from a test set device (e.g., one of terminals 2a or 2b of FIG. 2, or customer premises equipment 110 of FIG. 4), (ii) receive a response from the network device indicating a result of performing a diagnostic operation indicated by the diagnostic code, and (iii) forward the response to the test set device including an audio signal (e.g., audible response) indicating the result. An audio signal can include, for example, a voice response (e.g., using Interactive Voice Response (IVR)), or any other suitable type of audio signal. The storage device 310 also stores at least one prerecorded voice response message (e.g., a .WAV file or another type audio file format), or any other suitable type of audible response data as part of data 310a, and/or any suitable type of audible response instructions, such as, for example, instructions for IVR, as part of instructions 310b capable of providing the test set device with an audible response. Audible response instructions can include, for example, instructions for generating a voice response based on a non-voice response received from the network device.

In the case of a network device (e.g., ONU of FIG. 1, OLT 102, ONT 106a-n) supporting a signaling stack, the storage device 310 also stores instructions 310b which enable the system 300 to perform a diagnostic operation in response to receiving access information provided by a test set device (e.g., one of terminals 2a or 2b of FIG. 2, or customer premises equipment 110 of FIG. 4), and send a response to a user via the user's test set device via audible response, using, for example, IVR. The storage device 310 also stores at least one prerecorded voice response message, or any other suitable type of audible response data as part of data 310a, and/or any suitable type of audible response instructions, such as, for example, instructions for IVR, as part of instructions 310b.

As but one non-limiting example of diagnostic operations that may be employed and specified by the diagnostic code, an automated MLT Test procedure can be employed that automatically tests predetermined POTs interfaces and which can indicate whether one or more connections (e.g., RJ-11) to the relevant customer premises equipment 110 and/or wirings should be inspected and/or replaced. As another non-limiting example, an automated Draw Break Dial Tone Test (DBDT) can be employed that automatically tests the system 300's connection to the network (e.g., network 6 of FIG. 2) and which can indicate whether there is a network connection failure. As another non-limiting example, a self-test can be employed which can indicate whether the functionality of the system 300 is working properly. As another non-limiting example, an IP Ping can be employed that tests whether the system 300 can access an IP network.

Also according to an example aspect of the invention, alarms, the state of the system 300, and any other suitable type of diagnostic information can be reported. As but one non-limiting example, services (e.g., voice, data, video) enabled on an ONT can be reported. As another non-limiting example, an indication as to which fields for a service on the ONT have a provisioned value can be reported and/or verified. As another non-limiting example, network traffic metrics for a device can be reported. As another non-limiting example, a trace route operation can be performed from the system 300 that reports statistics from all other network devices between the system 300 and any specified network device, such as, for example, a SIP REGISTRATION server or a configuration server. The foregoing examples are not exhaustive, and it is within the scope of this invention to employ other types of diagnostic operations besides, or in addition to, those examples, depending on applicable operating criteria.

FIG. 6 is a flow diagram that illustrates a method in accordance with an example embodiment of this invention for initiating diagnostics remotely. At block 500, a field technician calls test head 44 from a test set device (e.g., 2a or 2b of FIG. 2, 110 of FIG. 4, or another type of communication device), for example, by dialing a telephone number or access code associated with test head 44. After test head 44 receives the call (block 501), test head 44 responds by instructing the technician to enter access information including, for example, (i) authenticating information, (ii) one or more identifiers identifying a network device having a signaling stack (e.g., ONU of FIG. 1, ONT 106a-n, and OLT 102), and (iii) at least one diagnostic code, as, for example, Dual-Tone Multi-Frequency (DTMF) key sequences and/or an audible response.

This instruction can be made using an audible response (e.g., IVR), such as for example, via the communication and playing of a prerecorded message (e.g., a .WAV file), or any other suitable type of audible response. The audible response can be generated and provided by test head 44, or generated by any one or more of the components ONU of FIG. 1, and 102, 106a-n, 130, 132, 134, and 136 of FIG. 4 and provided via test head 44. The audible response is received by the test set (e.g., telephone) through, for example, interface 42. The audible response signal (including, for example, data encoded as a .WAV file) is forwarded to controller 38 before being outputted through the speaker 32.

The field technician enters desired access information into the test set device, which provides the information to test head 44. The information can be inputted in an audible format provided through microphone 33, by operating keypad 36 to enter the information, or in any other suitable manner. In one example, the information is in the form of a DTMF sequence generated using the keypad (e.g., 36 of FIG. 3) of the test set device.

As described above, the diagnostic code may indicate, for example, a MLT test, a DBDT test, or a request for information, such as, for example, a network alarm state, a state of the ONT, or any other suitable type of diagnostic information.

At block 502, test head 44 receives the authenticating information, identifier, and diagnostic code provided at block 501 and determines whether the correct authenticating information has been provided.

In an example embodiment of the invention, the authenticating information is a usemame and password, and test head 44 uses a Lightweight Directory Access Protocol (LDAP) server to determine whether the username and password corresponds to an authorized user, or group of users, managed by the LDAP server. If the username and password correspond to an authorized user, or group of users, then the correct authenticating information has been provided.

In another example embodiment, the authentication information is a customer phone number (or access code) corresponding to an associated ONT and an ONT serial number. Test head 44 determines whether the provided phone number corresponds to the serial number using a carrier inventory database which stores combinations of phone numbers and matching ONT serial numbers. If the provided phone number corresponds to the serial number, then the correct authenticating information has been provided. Of course, in other embodiments, the authenticating can be performed using any other suitable authenticating technique at block 502.

If the correct authenticating information has not been provided (“NO” at block 502), processing proceeds to block 506 and ends. If the correct authenticating information has been provided (“YES” at block 502), processing proceeds to block 503 where test head 44 provides the network device identified by the identifier provided at block 501 with the diagnostic code and authenticating information. In an example embodiment of the invention, the network device may be an ONT and the identifier may be a phone number (or access code) corresponding to the ONT, and test head 44 can use, for example, a carrier inventory database to identify the ONT based on the phone number. In another example embodiment, the identifier may be a Uniform Resource Locator (URL) corresponding to the ONT, and test head 44 can use, for example, a Domain Name System (DNS) server to identify the ONT based on the URL. Of course, in other embodiments, the network device can be identified using any other suitable identifier at block 503.

According to an example embodiment of the invention, test head 44 provides the diagnostic code as a field of a session initiation method, such as, for example, a Session Initiation Protocol (SIP) INVITE method (message), although the code can be provided in other manners as well. The SIP INVITE method is sent to the ONT via soft switch 24, according to an example embodiment of the invention. The SIP INVITE method specifies a request to suppress “ringing” (“suppressed-ringing”) at the ONT when the ONT receives the SIP INVITE method, although in other embodiments that request is not included. The “suppressed-ringing” request instructs the ONT not to send a ringing voltage to, for example, CPE 100. In an example embodiment of the invention, test head 44 can end the SIP session with the ONT after providing the diagnostic code to the ONT, but in other embodiments, test head 44 can remain communicatively connected to the ONT via the created SIP session for a predetermined duration, after providing the diagnostic code.

At block 504, the ONT receives the SIP INVITE method, and in response to the SIP INVITE method specifying a diagnostic code and a “suppressed-ringing” request, removes the dial tone current from voice services data port 320 so that calls can not be made from the subscriber's premises (via the ONT corresponding to the identifier) using, for example, CPE 110. Thereafter, the ONT performs the diagnostic operation indicated by the diagnostic code. In other embodiments, the ONT simply performs the diagnostic operation in response to receiving the diagnostic code, without removing any dial tone.

As described above, the diagnostic operation may be, for example, a MLT test, a DBDT test, or a request for information, such as, for example, a network alarm state, a state of the ONT (e.g., the presence of SIP Alarms), or any other suitable type of diagnostic information. For example, for performing a DBDT test to test the ONT's connection to a network (e.g., PON 101), the ONT can use a SIP INVITE method to create a SIP session with, for example, soft switch 24. Soft switch 24 can, for example, respond with a SIP TRYING message, or any other suitable type of response message for acknowledging the successful creation of the SIP session. Additionally, soft switch 24 can, for example, signal test head 44, and instruct the ONT to send media (e.g., VoIP) traffic to test head 44 to test a media path between the ONT and another network device.

After the diagnostic operation is complete, processing proceeds to block 505 where the ONT sends a response to the test set device (e.g., 2a, 2b, or 110) used by the field technician indicating the results of the diagnostic operation, which can be provided to the technician via audible response (or via display 34, using Caller ID signaling, or via any other type of user perceptible communication), and the ONT restores the dial tone at voice services data port 320.

For example, for a diagnostic test (e.g., MLT or DBDT), the ONT can communicate a prerecorded message (e.g., a .WAV file) corresponding to a “Pass” or “Fail” result which is received and outputted by the test set. In response to a request for information (diagnostic code), such as, for example, the presence of SIP Alarms, the ONT can communicate a prerecorded message (e.g., a .WAV file) corresponding to a description of each SIP Alarm.

In an example embodiment of the invention, at block 505 the ONT first sends the response to test head 44 as a data response, such as, for example, a DTMF sequence, SIP method, or any other suitable type of response, identifying a prerecorded message (e.g., a .WAV file) corresponding to the result. Test head 44 generates an audible response by retrieving the indicated prerecorded message (e.g., from 310) and communicates the prerecorded message to the test set device (e.g., 2a, 2b, or 110) used by the field technician. For example, if the SIP session with test head 44 has not been ended, the ONT can send the response as a DTMF sequence. However, if the SIP session has been ended, the ONT uses a SIP INVITE method to create a new SIP session and the response is included as a field of the SIP INVITE method sent to test head 44. The test set device then outputs the message to the technician in a predetermined type of user perceptible format.

In another example embodiment of the invention, the authenticating information received at block 502 includes a phone number (or access code) for the test set device (e.g., 2a, 2b, or 110) used by the field technician, test head 44 provides the phone number for the test set device as a field of the SIP INVITE method at block 503, and at block 505 the ONT calls the test set device using the phone number, and sends the response directly to the test set device as a prerecorded message (e.g., a .WAV file stored in 310 of the ONT), in which case the message is presented to the technician. After the ONT sends the response, processing proceeds to block 506 and ends.

In this manner, a field technician receives diagnostic information resulting from performing the diagnostic operation, or identifying requested information, which can be used to troubleshoot a problem.

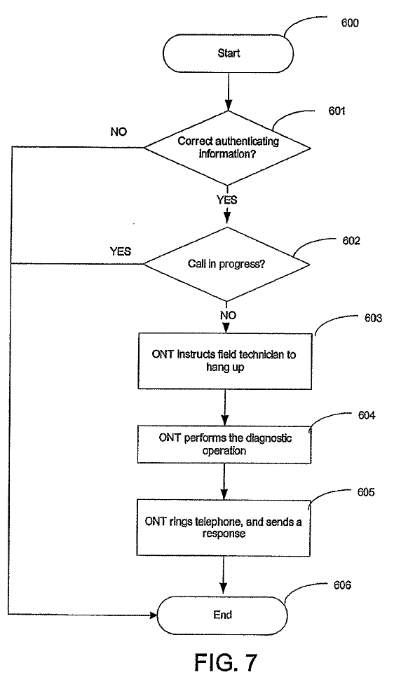

FIG. 7 is a flow diagram that illustrates a method in accordance with an example embodiment of this invention for initiating diagnostics locally. At block 600, a field technician is located at the subscriber's site to diagnose a network device, such as an ONT, after installation or ranging of the device, or in response to a notification of a problem with the subscriber's services, such as, for example, the absence of a dial tone, or any other type of problem. The technician plugs a test set (e.g., 2b of FIG. 2 or 110 of FIG. 4) into voice services data port 320 of the ONT (e.g., ONT 106a-n), and enters a predetermined diagnostic code (corresponding to a diagnostic operation desired to be performed) into the test set device (for example, by using a telephone keypad), and the test set device provides the diagnostic code to the ONT as, for example, a DTMF digit sequence. In an example embodiment of the invention, the field technician also provides authenticating information, such as, for example, a serial number of the ONT, a usemame and password, or any other suitable type of authenticating information to indicate that the field technician is authorized to initiate the diagnostic operation. The diagnostic code may indicate a diagnostic operation, or the like, as described above for FIG. 6.

At block 601, the ONT receives the diagnostic code and authenticating information provided in block 601 and determines whether the required authenticating information has been provided, as described above for FIG. 6.

If the required authenticating information has not been provided (“NO” at block 601), processing proceeds to block 606 and ends. If the required authenticating information has been provided (“YES” at block 601), processing proceeds to block 602 where the ONT determines whether there is a call in progress. If there is a call in progress (“YES” at block 602), processing proceeds to block 606 and ends. If there is not a call in progress (“NO” at block 602), processing proceeds to block 603 where the ONT provides instructions to the test set device which presents them to the field technician, instructing the technician to hang up (communicatively de-couple) the test set and wait for the ONT to signal the test set (i.e., ring 2b or 110). After the ONT detects the absence of a signal from the test set as a result of the test set being hung up (e.g., 2b or 110 is on-hook or not communicatively coupled to the ONT), processing proceeds to block 604 where the ONT performs the diagnostic operation indicated by the diagnostic code, as described above for FIG. 6. After the diagnostic operation is complete, processing proceeds to block 605 where the ONT signals the test set (i.e., rings), waits for a signal from the test set (i.e., 2b or 110 is off-hook) (indicating that the test set is again communicatively coupled to the ONT) in response to the ringing, and indicates the results of the diagnostic operation via audible response, as described above for FIG. 6, in response to receiving a signal from the test set. Thereafter, processing proceeds to block 606 and ends.

For example, if the test set is a standard landline telephone, the field technician can plug the telephone into voice services data port 320, and enter the diagnostic code into the telephone's keypad 36 along with authenticating information, such as, for example, the serial number of the ONT. This information is then provided by the telephone to the ONT via the port 320. If the authenticating information is determined by the ONT to be correct, then in one example embodiment of the invention, the ONT provides a prerecorded audible response message (e.g., a .WAV file stored in 310 of the ONT) that the telephone speaker 32 outputs. Upon receiving the message, the field technician can hang up the telephone, wait for the telephone to ring as a result of the ONT signaling it, answer the telephone, and then listen to another prerecorded response message provided by the ONT through the telephone, indicating the results of the diagnostic operation. For example, for a diagnostic test (e.g., MLT or DBDT), the ONT can communicate a prerecorded message (e.g., a .WAV file) corresponding to “Pass” or “Fail”, indicating the result of these tests. In response to a request for information, such as, for example, the presence of SIP Alarms, the ONT can communicate a prerecorded message (e.g., a .WAV file) corresponding to a description of each SIP Alarm. In other embodiments of the invention, block 603 is not performed, and the ONT simply responds to the diagnostic code by providing a result of the operation/request specified by the code to the technician, either directly or via the telephone, without requesting the technician to hang up the telephone.

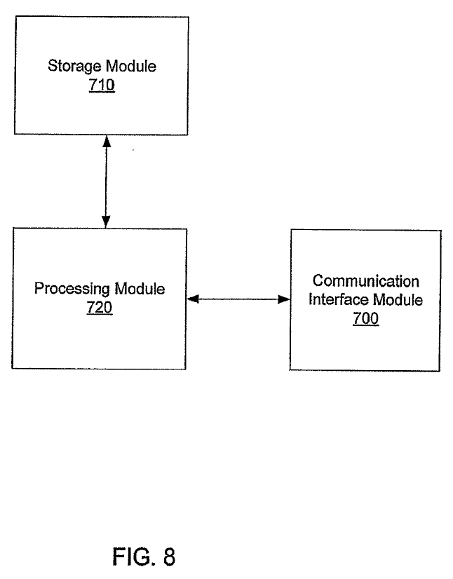

FIG. 8 is a logical diagram of modules in accordance with an example embodiment of the present invention. The modules may be of a data processing system or device 300, which, according to an example embodiment, can form individual ones of the components 44 of FIG. 2 and network devices supporting signaling stacks (e.g., ONU of FIG. 1, and 102 and 106a-n of FIG. 4). The modules may be implemented using hardcoded computational modules or other types of circuitry, or a combination of software and circuitry modules.

Communication interface module 700 controls communication device 314 by processing interface commands. Interface commands may be, for example, commands to send data, commands to communicatively couple with another device, or any other suitable type of interface command.

Storage device module 710 stores and retrieves data (e.g., audible response data) in response to requests from processing module 720.

In the case of at least the network devices supporting signaling stacks (e.g., ONU of FIG. 1, and 102 and 106a-n of FIG. 4), processing module 720 performs the procedures as described above in connection with FIGS. 6 and 7 for the network device. Processing module 720 performs a diagnostic operation in response to receiving access information received via communication interface module 700. The access information includes at least a diagnostic code indicating the diagnostic operation to be performed. After performing the diagnostic operation, processing module 720 retrieves response data from storage module 710 (e.g., a prerecorded message) corresponding to the result of performing the diagnostic operation, and sends a response, based on the response data, via communication interface module 700.

In the case of at least test head 44, processing module 720 performs the procedures as described above in connection with FIG. 6 for the test head 44. Processing module 720 receives a diagnostic code from a test set device (e.g., 2a, 2b, 110) via communication interface module 700 and forwards the diagnostic code to a network device (e.g., ONU of FIG. 1, and 102 and 106a-n of FIG. 4) via communication interface module 700. In response to receiving a response from the network device via communication interface module 700, processing module 720 forwards the response to the test set device via communication interface module 700. If the response received from the network device is not an audible response, processing module 720 retrieves audible response data from storage module 710 (e.g., a prerecorded message) corresponding to the response received from the network device. Thereafter, processing module 720 sends a response, based on the audible response data, to the test set, via communication interface module 700.

By virtue of the example methods, system, devices, and control logic of the invention described herein, field technicians can initiate diagnostics, for example, for an ONT, or another network device, during deployment at a subscriber's premises, or in response a notification of a problem with the subscriber's services. Instead of requesting another technician located at the EMS 130 to run the diagnostic operations from the EMS 130, the field technician can initiate diagnostics while at a subscriber's premises by directly connecting a test set device, such as a standard telephone, or any other user communication terminal, to the ONT, or can initiate diagnostics on the ONT remotely by calling a test head. In this manner, a field technician can initiate diagnostics without the intervention of another technician, thereby reducing manpower required to troubleshoot a problem and improve troubleshooting turnaround. Furthermore, because a commonly available test set device, such as, for example, a standard telephone, is used to initiate the diagnostic operations, the field technician can initiate diagnostics without using a specialized test set.

It should be noted that although the invention is described in the context of using a telephone or cellular radiotelephone (terminals 2a, and 2b), broadly construed, the invention can also be used with any other suitable types of user communication terminals, such as, for example, a portable PC docking node, a web TV, personal digital assistant, handheld personal digital assistant, palmtop computer, or pager, a PC, and the like. Moreover, the invention is not limited for use only for audible responses and messages, but other types of communications also can be employed depending on the capabilities of the user terminal(s) employed. For example, data, video, or another medium can be employed in lieu of or in conjunction with, audible communication, whether voice type or not.

In still another embodiment of the invention, the network device, such as an ONT, can be pre-programmed to enable the technician to interact with it directly instead of via a test set device, in order to initiate and obtain a result of a diagnostic operation or other information request, in a manner described above in conjunction with FIG. 7 but without use of the test set device.

In the foregoing description, the invention is described with reference to specific example embodiments thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software embodiments of the present invention may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive.

What is claimed is:

1. A method for initiating diagnostic operations in a communication network, the method comprising:
providing access information to a test head from a test set device, the access information comprising a diagnostic code indicating a diagnostic operation to be performed;
providing the diagnostic code to a network device from the test head; and
sending a response from the network device to the test set device, the response indicating a result of the diagnostic operation.

2. The method of claim 1, wherein the network device includes at least one of an optical network terminal (ONT), an optical network unit (ONU), and an optical line terminal (OLT).

3. The method of claim 1, wherein the test set device includes at least one of a telephone device and a computer with a soft phone.

4. The method of claim 1, wherein the diagnostic operation is performed at least in part by the network device.

5. The method of claim 1, wherein the diagnostic operation includes running a test and reporting network information.

6. The method of claim 5, wherein the test includes at least one of a Metallic Loop Test (MLT), a Draw Break Dial Tone Test (DBDT), an IP Ping, and a trace route, and the network information includes at least one of a network alarm state and a state of the network device.

7. The method of claim 1, wherein the access information is provided by the test set device as a DTMF digit sequence.

8. The method of claim 1, further comprising inputting the access information in the test set device in an audible format.

9. The method of claim 1, wherein the access information further comprises authenticating information.

10. The method of claim 1, wherein the test head provides the diagnostic code to the network device using a session initiation method, the session initiation method specifying a request to suppress ringing at the network device.

11. The method of claim 1, wherein the network device sends the response to the test set device via the test head.

12. The method of claim 1, wherein the network device sends the response to the test set device without providing the response to the test head.

13. The method of claim 1, wherein the response includes an audio signal indicating the result.

14. A method for initiating diagnostic operations in a communication network, the method comprising:
providing access information to a network device from a test set device, the access information comprising a diagnostic code indicating a diagnostic operation to be performed; and
sending a response from the network device to the test set device including an audio signal indicating a result of performing the diagnostic operation, after performance of the diagnostic operation.

15. The method of claim 14, further comprising:
instructing the test set device to communicatively de-couple from the network device;
performing the diagnostic operation in response to the test set device communicatively de-coupling from the network device;
communicatively coupling the network device and the test set device before sending the response.

16. The method of claim 14, wherein the network device includes at least one of an optical network terminal (ONT), an optical network unit (ONU), and an optical line terminal (OLT).

17. The method of claim 14, wherein the test set device includes at least one of a telephone device and a computer with a soft phone.

18. The method of claim 14, wherein the diagnostic operation is performed at least in part by the network device.

19. The method of claim 14, wherein the diagnostic operation includes running a test and reporting network information.

20. The method of claim 19, wherein the test includes at least one of a Metallic Loop Test (MLT), a Draw Break Dial Tone Test (DBDT), an IP Ping, and a trace route, and the network information includes at least one of a network alarm state and a state of the network device.

21. The method of claim 14, wherein the access information is provided as a DTMF digit sequence.

22. The method of claim 14, further comprising inputting the access information in the test set device in an audible format.

23. The method of claim 14, wherein the access information further comprises authenticating information.

24. A network device for initiating diagnostic operations, the device comprising:
a communication interface adapted to communicate with a test set device; and
a processor operable to (i) perform a diagnostic operation in response to receiving access information received through the communication interface, the access information comprising a diagnostic code indicating the diagnostic operation to be performed, and (ii) send a response to the test set device via the communication interface, the response indicating a result of performing the diagnostic operation,
wherein the response includes an audio signal indicating the result.

25. The network device of claim 24, wherein the network device includes at least one of an optical network terminal (ONT), an optical network unit (ONU), and an optical line terminal (OLT).

26. The network device of claim 24, wherein the test set device includes at least one of a telephone device and a computer with a soft phone.

27. The network device of claim 24, wherein the diagnostic operation includes at least one of running a test and reporting network information.

28. The network device of claim 27, wherein the test includes at least one of a Metallic Loop Test (MLT), a Draw Break Dial Tone Test (DBDT), an IP Ping, and a trace route, and the network information includes at least one of a network alarm state and a state of the network device.

29. The network device of claim 24, wherein the access information is received via a session initiation method, the session initiation method specifying a request to suppress ringing at the network device.

30. A computer-readable storage medium storing control logic for causing a computer to effect a diagnostic operation for a communication network, the control logic comprising:
first computer-readable program code to perform a diagnostic operation in response to access information being received, the access information comprising a diagnostic code indicating the diagnostic operation to be performed; and
second computer-readable program code to send a response indicating a result of performing the diagnostic operation,
wherein the response includes an audio signal indicating the result, and receivable by a test set device.

31. A test head for effecting a diagnostic operation, the test head comprising:
a communication interface adapted to communicate bi-directionally with a network; and
a processor operable to (i) provide a diagnostic code to a network device via the communication interface in response to receiving the diagnostic code through the communication interface from a test set device, (ii) receive a response from the network device through the communication interface, the response indicating a result of performing a diagnostic operation indicated by the diagnostic code, and (iii) forward the response to the test set device via the communication interface,
wherein the forwarded response includes an audio signal indicating the result.

32. The test head of claim 31, wherein the received response includes at least one of an audio signal, a DTMF digit sequence, and a session invite method.

33. The test head of claim 31, wherein the test head generates an audio signal based on a non-audible response received from the network device.

34. The test head of claim 31, wherein the network device includes at least one of an optical network terminal (ONT), an optical network unit (ONU), and an optical line terminal (OLT).

35. The test head of claim 31, wherein the test set device includes at least one of a telephone device and a computer with a soft phone.

36. The test head of claim 31, wherein the diagnostic code is provided by the test set as a DTMF digit sequence.

37. The test head of claim 31, wherein the diagnostic code is inputted in the test set device in an audible format.

38. The test head of claim 31, wherein the test head provides diagnostic code using a session initiation method, the session initiation method specifying a request to suppress ringing at the network device.

39. A computer-readable storage medium storing control logic for causing a computer to effect a diagnostic operation for a communication network, the control logic comprising:
first computer-readable program code to provide a diagnostic code to a network device;
second computer-readable program code to receive a response from the network device, the response indicating a result of performing a diagnostic operation indicated by the diagnostic code, and
third computer-readable program code to forward the response to a test set device,
wherein the response includes an audio signal indicating the result.
